(19) United States
(12) Patent Application Publication
(10) Pub. No.: US 2019/0241173 A1
(43) Pub. Date: Aug. 8, 2019

(54) DRIVE CONTROL DEVICE AND DRIVE CONTROL METHOD

(71) Applicant: MITSUBA Corporation, Gunma (JP)

(72) Inventors: TAKU SUZUKI, Gunma (JP); YOSHIKATSU HOSOYA, Gunma (JP); RYOTA HASHIMOTO, Gunma (JP); KEN HIROTA, Gunma (JP); TOMOKAZU AKUTSU, Gunma (JP)

(73) Assignee: MITSUBA Corporation, Gunma (JP)

(21) Appl. No.: 16/224,816

(22) Filed: Dec. 19, 2018

(30) Foreign Application Priority Data
Feb. 6, 2018 (JP) 2018-018920

(51) Int. Cl. B60W 10/14; B60W 10/08; B60K 7/00

(52) U.S. Cl. CPC B60W 10/14; B60W 2540/18; B60K 7/0007; B60W 10/08

(57) ABSTRACT

The disclosure includes a steering angle detection part detecting a steering angle of a handle for steering a front wheel of a vehicle, wherein the vehicle includes drive wheels, which are left and right rear wheels respectively provided with drive motors, and a steering wheel, which is the front wheel; a steering angle determination part determining whether the steering angle exceeds a predetermined steering angle reference value; and a motor control part reducing an output supplied to the drive motors of the rear wheels corresponding to a direction of the steering angle in a case that the steering angle determination part determines that the steering angle exceeds the steering angle reference value.

### CROSS-REFERENCE TO RELATED APPLICATION

This application claims the priority of Japan patent application serial no. 2018-018920, filed on Feb. 6, 2018. The entirety of the above-mentioned patent application is hereby incorporated by reference herein and made a part of this specification.

### BACKGROUND

### Technical Field

The disclosure relates to a drive control device and a drive control method.

### Description of Related Art

There are electric vehicles that drive the wheels by drive motors. For example, Patent Document 1 discloses an electric vehicle having drive motors respectively disposed on the left and right front wheels, and the electric vehicle is steered by one rear wheel. For such electric vehicles, there is also a demand for vehicles with the drive motors disposed on the rear wheels and using the front wheels as the steering wheels.

[Patent Document 1] Japanese Laid-open No. 2005-184978

However, for vehicles with the drive motors disposed on the rear wheels and using the front wheels as the steering wheels, when the steering angle of the handle exceeds a certain angle, a load is generated on the drive motor on the inner wheel side due to the inner wheel difference. Then, the outer drive wheel is rotated to the inner drive wheel side, and if speed feedback control is being performed, the output supplied to the drive motor is stopped. Thus, it affects the output reduction of the outer drive wheel and the inner drive wheel is under a high load, and furthermore a large current will flow to the drive motor of the drive wheel on the inner wheel side, resulting in problems such as overcurrent and an overheated state. In some cases, the controller that controls the drive motor may be damaged.

### SUMMARY

The disclosure provides a drive control device and a drive control method that can prevent a large current from flowing to the drive motor in a state of being in the steered direction, that is, a state where the drive wheel is under a high load, even if the steering angle exceeds a certain value.

The disclosure includes: a steering angle detection part detecting a steering angle of a handle for steering a front wheel of a vehicle, wherein the vehicle includes drive wheels, which are left and right rear wheels respectively provided with drive motors, and a steering wheel, which is the front wheel; a steering angle determination part determining whether the steering angle exceeds a predetermined steering angle reference value; and a motor control part reducing an output supplied to the drive motors of the rear wheels corresponding to a direction of the steering angle in a case of determining that the steering angle exceeds the steering angle reference value.

In addition, the disclosure relates to a drive control method including: detecting a steering angle of a handle for steering a front wheel of a vehicle by a steering angle detection part, wherein the vehicle includes drive wheels, which are left and right rear wheels respectively provided with drive motors, and a steering wheel, which is the front wheel; determining whether the steering angle exceeds a predetermined steering angle reference value by a steering angle determination part; and reducing an output supplied to the drive motors of the rear wheels corresponding to a direction of the steering angle by a motor control part in a case of determining that the steering angle exceeds the steering angle reference value.

As described above, according to the disclosure, by reducing the output supplied to the drive motor of the rear wheel corresponding to the direction of the steering angle, it is possible to prevent a large current from flowing in a state where the drive wheel in the steered direction is under a high load even if the steering angle exceeds a certain value.

### BRIEF DESCRIPTION OF THE DRAWINGS

FIG. 1 is a schematic configuration diagram showing an outline of the configuration, as viewed from the upper side, of the electric vehicle 1 to which the drive control device 10 according to an embodiment of the disclosure is applied.

FIG. 2 is a schematic configuration diagram illustrating a detection mechanism used for determining the area the steering angle is in.

FIG. 3 is a schematic functional block diagram showing functions of the drive control device 10.

FIG. 4 is a diagram illustrating the relationship between the detection result of each of the light receiving part 53, the Hall IC 56, and the Hall IC 58, each area, and the control content.

FIG. 5 is a flowchart illustrating the operation of the drive control device 10.

### DESCRIPTION OF THE EMBODIMENTS

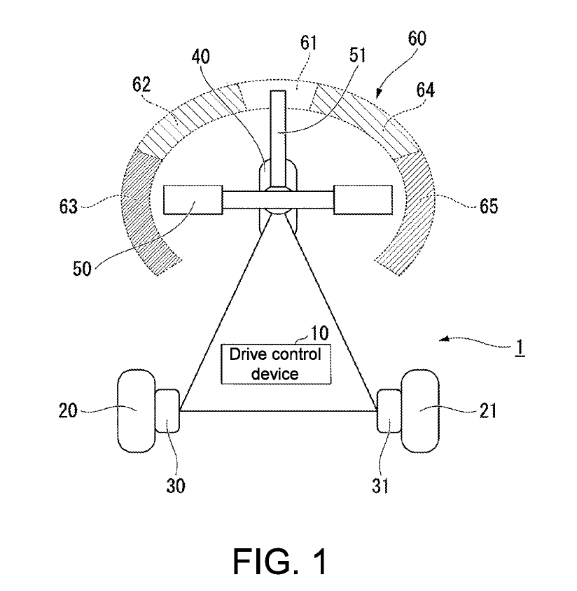

Hereinafter, a drive control device according to an embodiment of the disclosure will be described with reference to the drawings. FIG. 1 is a schematic configuration diagram showing an outline of the configuration, as viewed from the upper side, of an electric vehicle 1 to which a drive control device 10 according to an embodiment of the disclosure is applied. The electric vehicle 1 is, for example, a vehicle that runs in a low speed range with the maximum speed roughly up to the walking speed and can carry about one or two passengers. The electric vehicle 1 is, for example, an electric cart, a rollator, or the like, and can be used by a person who has difficulty walking or a healthy person. The drive control device 10 is installed in the electric vehicle 1. A drive wheel 20 and a drive wheel 21 are provided as the rear wheels of the electric vehicle 1. The drive wheel 20 is the left rear wheel and the drive wheel 21 is the right rear wheel. A drive motor 30 is disposed on the drive wheel 20 and a drive motor 31 is disposed on the drive wheel 21, and each motor individually drives in response to a control signal from the drive control device 10. A steering wheel 40 is provided as the front wheel of the electric vehicle 1. This figure illustrates a case where one wheel serves as the steering wheel, but two front wheels on the left and right sides may serve as steering wheels. A handle 50 is connected to the steering wheel 40 and is provided for steering the electric vehicle 1 according to an operation of the passenger. The handle 50 may be a rod-shaped handle or an annular handle (steering wheel). A connection member 51 is a plate-shaped member connected to the handle 50 and moves along the circumferential direction in a substantially horizontal direction corresponding to the steering direction of the handle 50. To be more specific, the connection member 51 moves to the left side in the circumferential direction when the handle 50 is steered to the left side and moves to the right side in the circumferential direction when the handle 50 is steered to the right side.

A determination target area 60 is set in advance according to the range of the steering angle of the handle 50. The determination target area 60 includes a center area 61, a left steering angle area 62, a left turning angle area 63, a right steering angle area 64, and a right turning angle area 65, and the respective areas are set not to interfere with each other. The center area 61 is set for a range of the steering angle for advancing the electric vehicle 1 in a generally straight direction, and the straight direction and a certain range in the left and right directions including the straight direction are set. The center area 61 is an area within the range of a steering angle reference value.

The left steering angle area 62 is set adjacent to the center area 61 in the direction that the steering angle is on the left side with respect to the center area 61. The left turning angle area 63 is set adjacent to the left steering angle area 62 in the direction that the steering angle is on the left side with respect to the left steering angle area 62. The right steering angle area 64 is set adjacent to the center area 61 in the direction that the steering angle is on the right side with respect to the center area 61. The right turning angle area 65 is set adjacent to the right steering angle area 64 in the direction that the steering angle is on the right side with respect to the right steering angle area 64.

The left steering angle area 62 and the right steering angle area 64 are set corresponding to a range of the steering angle for running without applying a large current to the drive motor 30 or the drive motor 31 even if an inner wheel difference occurs when the handle is steered to the left side or the right side. The left turning angle area 63 and the right turning angle area 65 are set corresponding to a range of the steering angle where there is a possibility that a large current may flow to the drive motor 30 or the drive motor 31 due to the inner wheel difference when the handle is further steered to the left side or the right side from the left steering angle area 62 or the right steering angle area 64.

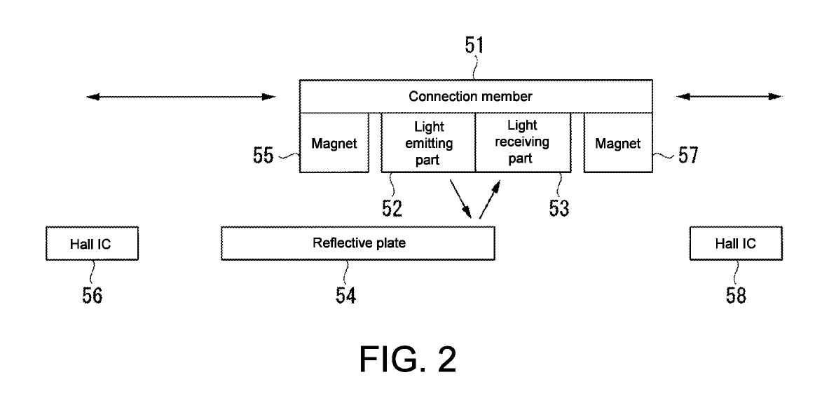

FIG. 2 is a schematic configuration diagram illustrating a detection mechanism used for determining the area the steering angle is in. This figure shows a cross section of the detection mechanism as viewed at the front side from the passenger of the electric vehicle 1. On the lower surface of the connection member 51, a light emitting part 52 and a light receiving part 53 are disposed in the center part, a magnet 55 is disposed on the left side (the left side end of the connection member) with respect to the vehicle traveling direction, and a magnet 57 is disposed on the right side (the right side end of the connection member) with respect to the vehicle traveling direction. As the connection member 51 moves to the left side or the right side according to the steering of the handle 50, the light emitting part 52, the light receiving part 53, the magnet 55, and the magnet 57 also move to the left side or the right side. The light emitting part 52 emits light to emit infrared light, for example. The light receiving part 53 receives the light emitted from the light emitting part 52. For example, infrared sensors can be used as the light emitting part 52 and the light receiving part 53. A reflective plate 54 is a plate-shaped member disposed in the electric vehicle 1 independently of the connection member 51, and is arranged to extend in the plane direction in the region corresponding to the center area 61. By disposing the reflective plate 54 corresponding to the region of the range of the steering angle reference value, the reflective plate 54 functions as an area prompt part. In addition, the reflective plate 54 does not move according to the steering of the handle 50. In the case that the steering angle of the handle 50 is within the range of the steering angle reference value, since the light emitting part 52 and the light receiving part 53 of the connection member 51 are within the range of the steering angle reference value (center area 61), by disposing the reflective plate 54 in the range of the steering angle reference value, the light receiving part 53 can receive the light from the light emitting part 52 reflected by the reflective plate 54. In the case that the handle 50 is steered beyond the range of the steering angle reference value, the light emitting part 52 and the light receiving part 53 are outside the region where the reflective plate 54 is disposed, so the light receiving part 53 cannot receive the light from the light emitting part 52. Thus, based on whether the light receiving part 53 can receive the light from the light emitting part 52, it is possible to grasp whether the steering angle of the handle 50 is in the center area 61 (within the range of the steering angle reference value).

The Hall IC 56 is disposed in a region corresponding to a turning angle reference value when the handled 50 is steered to the left side and functions as a turning angle reference position prompt part. The Hall IC 56 is attached to the left side in the horizontal direction away from the end of the reflective plate 54 and is disposed at a position corresponding to the boundary between the left steering angle area 62 and the left turning angle area 63. The Hall IC 58 is disposed in a region corresponding to a turning angle reference value when the handle 50 is steered to the right side and functions as a turning angle reference position prompt part. The Hall IC 58 is attached to the right side in the horizontal direction away from the end of the reflective plate 54 and is disposed at a position corresponding to the boundary between the right steering angle area 64 and the right turning angle area 65. The Hall IC 56 and the Hall IC 58 function as steering angle prompt parts. For example, magnetic sensors can be used as the Hall IC 56 and the Hall IC 58.

In the case that the steering angle of the handle 50 is in any of the center area 61, the left steering angle area 62, and the right steering angle area 64, since both the magnet 55 and the magnet 57 of the connection member 51 are in one of the center area 61, the left steering angle area 62, and the right steering angle area 64, the magnet 55 and the magnet 57 of the connection member 51 do not reach the range that can be detected by the Hall IC 56 and the Hall IC 58. In the case that the handle 50 is further steered to the left side beyond any one of the left steering angle area 62 and the right steering angle area 64, the magnet 55 reaches the range that can be detected by the Hall IC 56, or in the case that the handle 50 is steered to the right side, the magnet 57 reaches the range that can be detected by the Hall IC 58. Thus, in the case that the Hall IC 56 detects that the magnet 55 is approaching, it can detect that the steering angle of the handle 50 has reached the left steering angle area 62, and in the case that the Hall IC 58 detects that the magnet 57 is approaching, it can detect that the steering angle of the handle 50 has reached the right steering angle area 64.

As shown in this figure, the light emitting part 52, the light receiving part 53, the magnet 55, and the magnet 57 can move relative to the reflective plate 54, the Hall IC 56, and the Hall IC 58 in the horizontal direction according to the steering of the handle 50. In this figure, it is arranged so that when the Hall IC 56 or the Hall IC 58 detects the magnet, no light is received by the light receiving part 53. This figure illustrates a case where the light emitting part 52 and the light receiving part 53 are arranged in line with the movement direction of the connection member 51. However, the arrangement is not limited thereto if it allows the light emitted by the light emitting part 52 and reflected by the reflective plate 54 to be received by the light receiving part 53. For example, the light emitting part 52 and the light receiving part 53 may be arranged side by side to be on the front side and the rear side when viewed at the front side from the passenger of the electric vehicle 1.

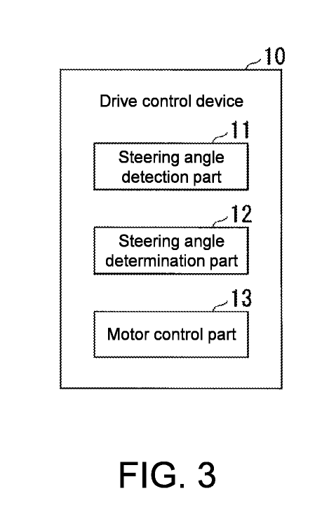

FIG. 3 is a schematic functional block diagram showing functions of the drive control device 10. The drive control device 10 includes a steering angle detection part 11, a steering angle determination part 12, and a motor control part 13. The steering angle detection part 11 detects occurrence of the inner wheel difference by detecting the area (the center area 61, the left steering angle area 62, the left turning angle area 63, the right steering angle area 64, or the right turning angle area 65) that the steering angle of the handle is in. For example, three sets of sensors are used. Here, the steering angle detection part 11 can be configured with a combination of the light emitting part 52, the light receiving part 53, and the reflective plate 54 (steering angle sensor), a combination of the magnet 55 and the Hall IC 56 (turning angle sensor), and a combination of the magnet 57 and the Hall IC 58 (turning angle sensor).

The steering angle determination part 12 determines whether the steering angle exceeds the predetermined steering angle reference value. In the case of determining that the steering angle exceeds the steering angle reference value, the motor control part 13 reduces the output supplied to the drive motor of the rear wheel corresponding to the direction of the steering angle.

The steering angle determination part 12 determines whether the steering angle exceeds a turning angle reference value which is an angle reference value larger than the steering angle reference value. The steering angle determination part 12 determines that the steering angle exceeds the steering angle reference value in a case that the steering angle is not within the region corresponding to the surface of the reflective plate 54 based on the detection result of the light receiving part 53. The steering angle determination part 12 determines that the steering angle exceeds the turning angle reference value, that is, the steering angle reaches the left turning angle area 63 or the right turning angle area 65 in a case that the Hall IC 56 and the magnet 55 reach the corresponding positions or in a case that the Hall IC 58 and the magnet 57 reach the corresponding positions after the steering angle exceeds the steering angle reference value.

The motor control part 13 stops the output for the drive motor in a case that the steering angle exceeds the turning angle reference value. The motor control part 13 supplies the output to the drive motor in a case that the steering angle reaches to less than the steering angle reference value after exceeding the turning angle reference value.

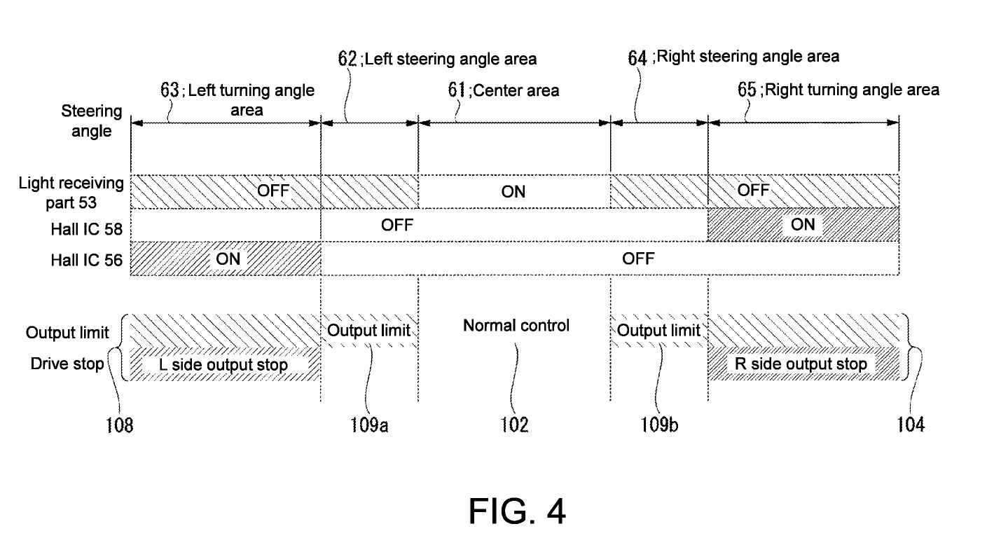

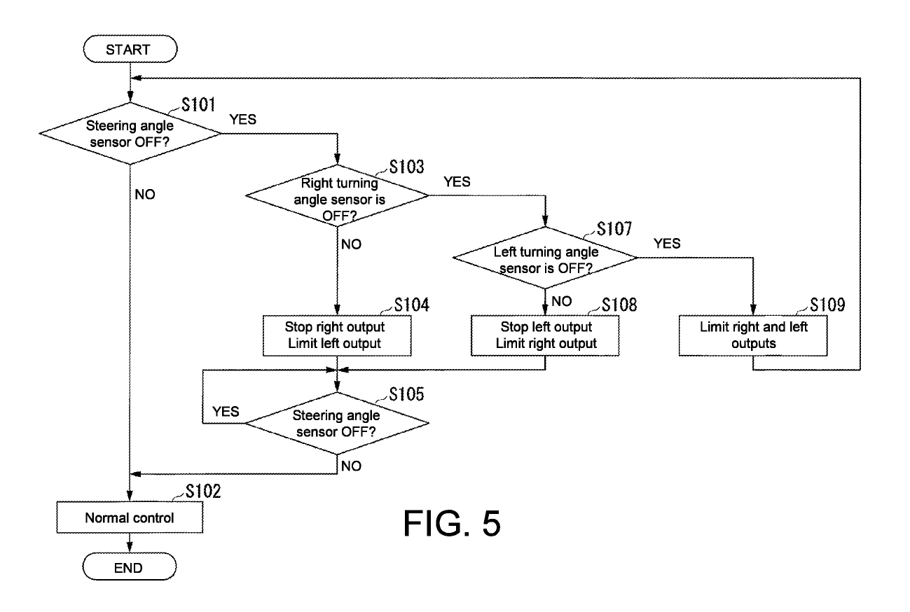

Next, the operation of the drive control device 10 will be described with reference to FIG. 4 and FIG. 5. FIG. 4 is a diagram illustrating the relationship between the detection result of each of the light receiving part 53, the Hall IC 56, and the Hall IC 58, each area, and the control content. FIG. 5 is a flowchart illustrating the operation of the drive control device 10. The steering angle determination part 12 of the drive control device 10 determines whether the steering angle sensor is OFF, that is, whether the light receiving result of the light receiving part 53 indicates OFF showing that the light from the light emitting part 52 is not detected when the operation of the electric vehicle 1 is started (FIG. 5; step S101). In a case that the detection result of the light receiving part 53 is not OFF, that is, in a case that the detection result is ON as the light from the light emitting part 52 reflected by the reflective plate 54 is received (FIG. 4; the light receiving part 53 is ON in the center area 61, FIG. 5; step S101-NO), the steering angle determination part 12 determines that the steering angle of the handle 50 is in the center area 61 and outputs the determination result to the motor control part 13. When the motor control part 13 obtains the determination result indicating that the steering angle is in the center area 61, the motor control part 13 performs normal control to supply the output according to an operation amount of the accelerator to the drive motor 30 and the drive motor 31 (FIG. 4; reference numeral 102, FIG. 5; step S102). By performing normal control, the motor control part 13 supplies the output for driving the drive motor 30 and the drive motor 31 according to the opening degree of the accelerator. The supply of the output may be supply of a control signal according to a voltage level or a current value indicating to drive the drive motor 30 and the drive motor 31.

On the other hand, in a case that the detection result of the light receiving part 53 is OFF, that is, in a case that the detection result is OFF as the light from the light emitting part 52 reflected by the reflective plate 54 is not received (step S101-YES), the steering angle determination part 12 determines whether the right turning angle sensor is OFF, that is, whether the Hall IC 58 is OFF (FIG. 5; step S103). In a case that the Hall IC 58 is not OFF but ON (FIG. 4; the Hall IC 58 is ON in the right turning angle area 65, FIG. 5; step S103-NO), the steering angle determination part 12 determines that the steering angle of the handle 50 reaches the right turning angle area 65 and outputs the determination result to the motor control part 13. Such a case corresponds to a case where the steering angle of the handle 50 moves from the center area 61 to the right steering angle area 64 and further moves to the right turning angle area 65. When the motor control part 13 obtains the determination result indicating that the steering angle reaches the right turning angle area 65, the motor control part 13 stops the output to the drive motor 31 (right drive wheel) and limits the output to the drive motor 30 (left drive wheel) to reduce the output (FIG. 4; reference numeral 104, FIG. 5; step S104). Here, by stopping the output to the drive motor 31, it is possible to set the drive motor 31 free. Since no control signal or the like is supplied to the drive motor 31, supply of a large current to the drive motor 31 can be prevented. Therefore, it is possible to prevent overcurrent or an overheated state in the drive control device 10. Further, by limiting the output to the drive motor 30, it is possible to prevent the speed from increasing during turning.

Next, the steering angle determination part 12 determines whether the steering angle sensor is OFF, that is, whether the light receiving result of the light receiving part 53 indicates OFF showing that the light from the light emitting part 52 is not detected (FIG. 5; step S105). In a case that the light receiving result of the light receiving part 53 indicates OFF (FIG. 5; step S105-YES), the steering angle determination part 12 performs the determination of step S105 again after a wait time which is a fixed time elapses. On the other hand, in a case that the light receiving result of the light receiving part 53 does not indicate OFF (indicates ON) (FIG. 5; step S105-NO), the steering angle determination part 12 outputs to the motor control part 13 the determination result showing that the light receiving result of the light receiving part 53 indicates ON. Here, in a case that the steering angle of the handle 50 returns from the right turning angle area 65 to the center area 61 through the right steering angle area 64, the light receiving result of the light receiving part 53 becomes ON. In a case that the light receiving result of the light receiving part 53 is ON, the motor control part 13 shifts to normal control (FIG. 4; reference numeral 102, FIG. 5; step S102). By shifting to normal control, the output to the drive motor 30 and the drive motor 31 is not reduced and is supplied according to the operation amount of the accelerator, and the electric vehicle 1 can advance in the traveling direction.

Further, in step S103, in a case that the Hall IC 58 is OFF, the steering angle determination part 12 determines whether the Hall IC 56 is OFF (FIG. 5; step S107). In a case that the Hall IC 56 is not OFF (ON) (FIG. 4: the Hall IC 56 is ON in the left turning angle area 63, FIG. 5; step S107-NO), the steering angle determination part 12 determines that the steering angle of the handle 50 reaches the left turning angle area 63 and outputs the determination result to the motor control part 13. When the motor control part 13 obtains the determination result indicating that the steering angle reaches the left turning angle area 63, the motor control part 13 stops the output to the drive motor 30 (left drive wheel) and limits the output to the drive motor 31 (right drive wheel) to reduce the output (FIG. 4; reference numeral 108, FIG. 5; step S108). Here, by stopping the output to the drive motor 30, it is possible to set the drive motor 30 free. Since no control signal or the like is supplied to the drive motor 30, supply of a large current to the drive motor 30 can be prevented. Therefore, it is possible to prevent overcurrent or an overheated state in the drive control device 10. Further, by limiting the output to the drive motor 31, it is possible to prevent the speed from increasing during turning.

Next, the steering angle determination part 12 determines whether the steering angle sensor is OFF, that is, whether the light receiving result of the light receiving part 53 indicates OFF showing that the light from the light emitting part 52 is not detected (FIG. 5; step S105). In a case that the light receiving result of the light receiving part 53 indicates OFF (FIG. 5; step S105-YES), the steering angle determination part 12 performs the determination of step S105 again after the wait time which is a fixed time elapses. On the other hand, in a case that the light receiving result of the light receiving part 53 does not indicate OFF (indicates ON) (FIG. 5; step S105-NO), the steering angle determination part 12 outputs to the motor control part 13 the determination result showing that the light receiving result of the light receiving part 53 indicates ON. Here, in a case that the steering angle of the handle 50 returns from the left turning angle area 63 to the center area 61 through the left steering angle area 62, the light receiving result of the light receiving part 53 becomes ON. In a case that the light receiving result of the light receiving part 53 is ON, the motor control part 13 shifts to normal control (FIG. 4; reference numeral 102, FIG. 5; step S102). By shifting to normal control, the output to the drive motor 30 and the drive motor 31 is not reduced and is supplied according to the operation amount of the accelerator, and the electric vehicle 1 can advance in the traveling direction.

On the other hand, in step S107, in a case that the Hall IC 56 is OFF (FIG. 5; step S107-YES), the steering angle determination part 12 outputs to the motor control part 13 the determination result showing that the steering angle of the handle 50 is in either the left steering angle area 62 or the right steering angle area 64. Such a case corresponds to a case where the steering angle of the handle 50 moves from the center area 61 to the left steering angle area 62, or a case where the steering angle moves from the center area 61 to the right steering angle area 64. When the motor control part 13 obtains the determination result showing that the steering angle is in either the left steering angle area 62 or the right steering angle area 64, the output to the drive motor 30 (left drive wheel) and the drive motor 31 (right drive wheel) is limited to reduce the output (FIG. 4; reference numerals 109a and 109b, FIG. 5; step S109). Here, by limiting the output to the drive motor 30 and the drive motor 31, it is possible to suppress the speed from increasing during turning.

In the embodiment described above, in a case that the steering angle reaches the right turning angle area 65 and causes the output to the drive motor 31 to be stopped in step S104, or in a case that the steering angle reaches the left turning angle area 63 and causes the output to the drive motor 30 to be stopped in step S108, the output is continued to be stopped until the light receiving part 53 is set ON again (the steering angle sensor is set ON again). Thus, for example, in a case that the magnet 55 moves further to the left side after reaching the position corresponding to the Hall IC 56 and causes the Hall IC 56 to be set OFF, or in a case that the magnet 57 moves further to the right side after reaching the position corresponding to the Hall IC 58 and causes the Hall IC 58 to be set OFF, the stop of the output to the drive motor 30 or the drive motor 31 can be continued. Therefore, it is unnecessary to detect the entire area of the left turning angle area 63 or the right turning angle area 65 as the detection target, and it is only required to detect that the steering angle has reached the left turning angle area 63 beyond the boundary between the left steering angle area 62 and the left turning angle area 63, and that the steering angle has reached the right turning angle area 65 beyond the boundary between the right steering angle area 64 and the right turning angle area 65. Accordingly, it is possible to reduce the sensing area for the left turning angle area 63 and the right turning angle area 65. Since the area the steering angle is in can be determined based on whether the detection result obtained from the sensor is ON or OFF, it is not absolutely necessary to use angle sensors, high-performance CPUs, etc. Therefore, the configuration of these sensors can be simplified and the costs can be reduced. In particular, for senior cars (may be referred to as handle type electric wheelchairs or electric carts) that run at the same speed as a pedestrian or personal mobility that runs at a lower speed than a vehicle such as an automobile, while the costs are reduced in terms of price, the disclosure is sufficiently effective.

Moreover, for the region where only the detection result of the light receiving part 53 is OFF, it is possible to limit the output to the drive motor 30 and the drive motor 31 without identifying whether the steering angle is steered to the left side or to the right side. Thus, the configuration of these sensors can be simplified and the costs can be reduced.

In the above embodiment, the light emitting part 52 and the light receiving part 53 may be Hall ICs and the reflective plate 54 may be a plate-shaped magnet. In that case, it is preferable to dispose the Hall ICs at a distance so as not to detect the magnet 55 and the magnet 57 attached to the connection member. Further, although the magnet 55 is disposed in the connection member 51 and the Hall IC 56 is disposed in the electric vehicle 1, the magnet 55 may be disposed in the electric vehicle 1 and the Hall IC 56 may be disposed in the connection member 51, or the magnet 57 may be disposed in the electric vehicle 1 and the Hall IC 58 may be disposed in the connection member 51.

Although the embodiment of the disclosure has been described in detail above with reference to the drawings, the specific configuration is not limited to this embodiment, and any design that does not depart from the spirit of the disclosure is included.

What is claimed is:

1. A drive control device, comprising:
a steering angle detection part detecting a steering angle of a handle for steering a front wheel of a vehicle, wherein the vehicle comprises drive wheels, which are left and right rear wheels respectively provided with drive motors, and a steering wheel, which is the front wheel;
a steering angle determination part determining whether the steering angle exceeds a predetermined steering angle reference value; and
a motor control part reducing an output supplied to the drive motors of the rear wheels corresponding to a direction of the steering angle in a case of determining that the steering angle exceeds the steering angle reference value.

2. The drive control device according to claim 1, wherein the steering angle determination part determines whether the steering angle exceeds a turning angle reference value which is an angle reference value larger than the steering angle reference value, and
the motor control part stops the output for the drive motors in a case that the steering angle exceeds the turning angle reference value.

3. The drive control device according to claim 2, wherein the motor control part supplies the output to the drive motors in a case that the steering angle reaches to less than the steering angle reference value after the steering angle exceeds the turning angle reference value.

4. The drive control device according to claim 1, comprising:
an area prompt part disposed corresponding to a region within a range of the steering angle reference value; and
an area detection part disposed in a connection member, which is connected to the handle and movable in a steering direction according to steering of the handle, and detecting whether the steering angle is at a position corresponding to the region of the area prompt part,
wherein the steering angle determination part determines that the steering angle exceeds the steering angle reference value in a case that the steering angle is not within the region of the area prompt part based on a detection result of the area detection part.

5. The drive control device according to claim 2, comprising:
a turning angle reference position prompt part disposed in a region corresponding to the turning angle reference value; and
a steering angle prompt part disposed in a connection member connected to the handle and movable in a steering direction according to steering of the handle,
wherein the steering angle determination part determines that the steering angle exceeds the turning angle reference value in a case that the turning angle reference position prompt part and the steering angle prompt part reach corresponding positions after the steering angle exceeds the steering angle reference value.

6. A drive control method, comprising:
detecting a steering angle of a handle for steering a front wheel of a vehicle by a steering angle detection part, wherein the vehicle comprises drive wheels, which are left and right rear wheels respectively provided with drive motors, and a steering wheel, which is the front wheel;
determining whether the steering angle exceeds a predetermined steering angle reference value by a steering angle determination part; and
reducing an output supplied to the drive motors of the rear wheels corresponding to a direction of the steering angle by a motor control part in a case of determining that the steering angle exceeds the steering angle reference value.
